(19) United States
(12) Patent Application Publication
(10) Pub. No.: US 2026/0067777 A1
(43) Pub. Date: Mar. 5, 2026

(54) PACKET LOSS BASED HANDOVERS FOR A WIRELESS COMMUNICATION DEVICE

(71) Applicant: T-MOBILE INNOVATIONS LLC, Overland Park, KS (US)

(72) Inventors: Uday Yagnesh Dave, Sammamish, WA (US); Noshad Bagha, Shoreline, WA (US); Adeel Ahmed, Bellevue, WA (US); Veeranjaneya Murthy Puja, Snoqualmie, WA (US)

(21) Appl. No.: 18/825,679

(22) Filed: Sep. 5, 2024

(51) Int. Cl. H04W 36/30; H04L 43/0829; H04L 43/087; H04W 84/06

(52) U.S. Cl. CPC H04W 36/30; H04L 43/0829; H04L 43/087; H04W 84/06

(57) ABSTRACT

A data communication system identifies a target wireless access node for a wireless communication device. The data communication system determines a packet loss characteristic for a wireless transfer of packet data between the wireless communication device and a source wireless access node. The data communication system requests a handover of the wireless communication device from the source wireless access node to the target wireless access node in response to the packet loss characteristic.

### TECHNICAL BACKGROUND

Wireless communication networks provide wireless data services to wireless communication devices like phones, computers, and other user devices. The wireless data services may include internet-access, data messaging, video conferencing, or some other data communication product. The wireless communication devices come in different types based on model, configuration, operating system, slice identifier, and user application. The wireless communication networks comprise wireless access nodes like Wireless Fidelity (WIFI) hotspots, Fifth Generation New Radio (5GNR) cell towers, and satellites in earth orbit. The wireless communication networks further comprise network elements the process network signaling and handle user data like Access and Mobility Management Functions (AMFs) and User Plane Functions (UPFs).

A wireless communication device wirelessly exchanges user data with a serving wireless access node. As a wireless communication device moves about, the wireless communication device also detects a target wireless access node. When the signal strength from the target wireless access node exceeds the signal strength from the source wireless access node, the source wireless access node hands over the wireless communication device to the target wireless access node. The wireless communication device then wirelessly exchanges user data with the target wireless access node but not with the serving wireless access node.

### TECHNICAL OVERVIEW

In some examples, a method comprises the following. Identify a target wireless access node for a wireless communication device. Determine a packet loss characteristic for a wireless transfer of packet data between the wireless communication device and a source wireless access node. Request a handover of the wireless communication device from the source wireless access node to the target wireless access node in response to the packet loss characteristic.

In some examples, a method comprises the following. A source wireless access node wirelessly exchange packet data with a wireless communication device. A data communication control system identifies a target wireless access node for the wireless communication device. The data communication control system identifies a packet loss characteristic for the wireless exchange of the packet data between the source wireless access node and the wireless communication device. The data communication control system initiates a handover of the wireless communication device from the source wireless access node to the target wireless access node in response to the packet loss characteristic. The target wireless access node wirelessly exchange additional packet data with the wireless communication device.

In some examples, a wireless communication device comprises a device radio system and a device control system. The device radio system wirelessly transfers packet data between the wireless communication device and a source wireless access node. The device radio system wirelessly receives a target signal from a target wireless access node. The device control system identifies the target wireless access node based on the target signal. The device control system determines a packet loss characteristic for the wireless transfer of the packet data between the wireless communication device and the source wireless access node. The device control system requests a handover from the source wireless access node to the target wireless access node in response to the packet loss characteristic and the target signal. The device radio system wirelessly transfers additional packet data between the wireless communication device and the target wireless access node.

### DESCRIPTION OF THE DRAWINGS

FIG. 1 illustrates an exemplary data communication system to handover a wireless communication device based on packet loss.

FIG. 2 is a flow diagram that illustrates an exemplary operation of the data communication system to handover the wireless communication device based on packet loss.

FIG. 3 is a protocol flow that illustrates an exemplary operation of the data communication system to handover the wireless communication device based on packet loss.

FIG. 4 illustrates exemplary processing circuitry to handover a wireless communication device based on packet loss.

FIG. 5 illustrates an exemplary wireless communication network that hands over a wireless User Equipment (UE) based on packet loss.

FIG. 6 illustrates an exemplary wireless UE in the wireless communication network that hands over the wireless UE based on packet loss.

FIG. 7 illustrates an exemplary Fifth Generation New Radio (5GNR) Access Node (AN) in the wireless communication network that hands over the wireless UE based on packet loss.

FIG. 8 illustrates an exemplary Wireless Fidelity (WIFI) AN in the wireless communication network that hands over the wireless UE based on packet loss.

FIG. 9 illustrates an exemplary Satellite (SAT) AN node and SAT Ground Station (GND) in the wireless communication network that hands over the wireless UE based on packet loss.

FIG. 10 illustrates an exemplary Network Function Virtualization Infrastructure (NFVI) in the wireless communication network that hands over the wireless UE based on packet loss.

FIGS. 11-13 illustrate an exemplary operation of the wireless communication network to handover the wireless UE from the WIFI AN to the 5GNR AN based on packet loss and user application.

FIGS. 14-16 illustrate an exemplary operation of the wireless communication network to handover the wireless UE from the SAT AN to the 5GNR AN based on packet loss and slice identifier.

FIGS. 17-19 illustrate an exemplary operation of the wireless communication network to handover the wireless UE from the WIFI AN to the SAT AN based on packet loss and UE type.

### DETAILED DESCRIPTION

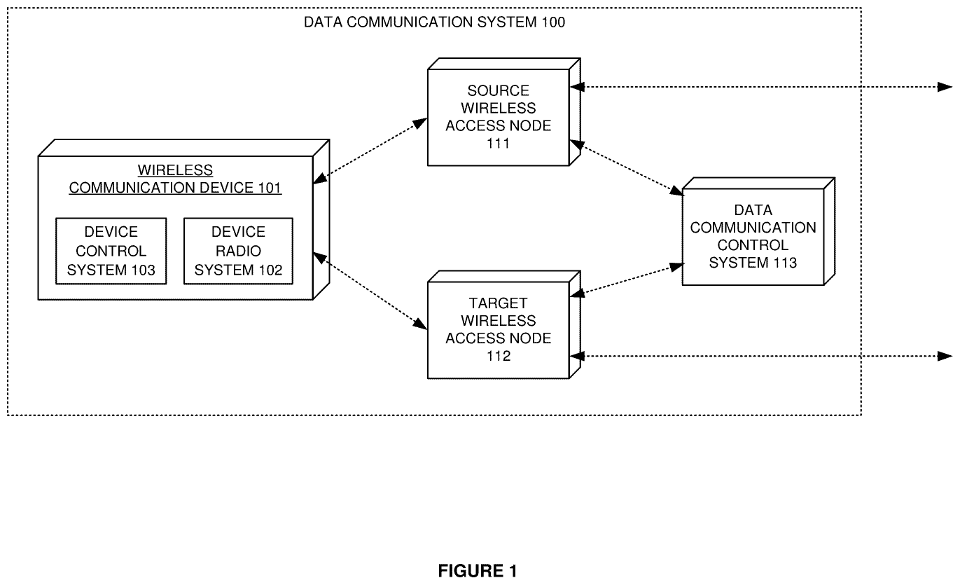

FIG. 1 illustrates exemplary data communication system 100 to handover wireless communication device 101 based on packet loss. Data communication system 100 comprises wireless communication device 101, source wireless access node 111, target wireless access node 112, and data communications control system 113. Wireless communication device 101 comprises device radio system 102 and device control system 103.

Wireless communication device 101 comprises a phone, watch, tablet, sensor, or some other user apparatus with wireless communication components. Wireless access nodes 111-112 comprise Fifth Generation New Radio (5GNR) base stations, Wireless Fidelity (WIFI) hotspots, communication satellites, or some other network element with wireless communication components. Data communication control system 113 comprises an Access and Mobility Management Function (AMF), Session Management Function (SMF), Unified Data Management (UDM), or some other network function. Some or all of data communication control system 113 could be integrated within wireless communication device 101, source wireless access node 111, and/or target wireless access node 112.

In operation, device radio system 102 wirelessly receives a target signal from target wireless access node 112 and transfers target signal information to device control system 103. Device control system 103 identifies target wireless access node 112 and determines a signal characteristic like received signal strength based on the target signal information. Device radio system 102 and source wireless access node 111 wirelessly exchange packet data. Device control system 103 determines a packet loss characteristic for the wireless transfer of the packet data between device radio system 102 and source wireless access node 111. For example, device control system 103 may determine the percentage of lost data packets from the total amount of transferred data packets. Device control system 103 requests a handover from source wireless access 111 node to target wireless access node 112 in response to the packet loss characteristic and the target signal characteristic. The handover request indicates the packet loss characteristic for wireless access node 111 and the target strength characteristic for target wireless access node 112. Data communication control system 113 identifies target wireless access node 112 for wireless communication device 101 in response to the handover request from device control system 103. Data communication control system 113 initiates a handover of wireless communication device 101 from source wireless access node 111 to target wireless access node 112 in response to the packet loss characteristic and the target signal characteristic in the handover request. Device radio system 102 and target wireless access node 112 wirelessly transfer additional packet data. Although an uplink/downlink data exchange is described above, data transfers that are only uplink or only downlink could be used in a similar manner where the packet loss characteristic initiates the handover.

In some examples, device control system 103 identifies a time interval that is based on a device type for wireless communication device 101. The device type comprises models, configurations, operating system, slice identifiers, user applications, and/or some other characteristic of wireless communication device 101. Device control system 103 collects packet loss information from device radio system 102 during successive time intervals for the wireless exchange of the packet data. Device control system 103 determines an average packet loss rate based on the packet loss information. At the end of each time interval, device control system 103 processes the average packet loss rate and the average target signal strength to determine if a handover should be requested, and if so, device control system 103 transfers the handover request to data communication control system 113. For example, device control system 103 may determine that the packet loss rate exceeds 15% and the target signal strength exceeds −92 decibel-milliwatts (DBm), and in response, device control system 103 transfers the handover request. Data communication control system 113 also processes the packet loss rate and the target signal strength to determine if the handover should be initiated. If so, data communication control system 113 transfers signaling to initiate the handover.

In some examples, device control system 103 determines a jitter characteristic for the wireless transfer of the packet data between device radio system 102 and source wireless access node 111. Device control system 103 requests a handover from source wireless access 111 node to target wireless access node 112 in response to the packet loss characteristic, the jitter characteristic, and the target signal characteristic. The handover request indicates the packet loss characteristic, jitter characteristic, and target strength characteristic. Data communication control system 113 initiates a handover of wireless communication device 101 from source wireless access node 111 to target wireless access node 112 in response to the packet loss characteristic, jitter characteristic, and the target signal characteristic in the handover request. In some examples, the jitter characteristic and target strength characteristic may be used to initiate the handover without the use of packet loss.

Wireless communication device 101 and wireless access nodes 111-112 may wirelessly communicate using wireless protocols like Wireless Fidelity (WIFI), Fifth Generation New Radio (5GNR), Long Term Evolution (LTE), Low-Power Wide Area Network (LP-WAN), Near-Field Communications (NFC), Code Division Multiple Access (CDMA), Frequency Division Multiple Access (FDMA), Time Division Multiple Access (TDMA), and satellite data communications. Wireless communication device 101, wireless access nodes 111-112, and data communication control system 113 comprise microprocessors, software, memories, transceivers, bus circuitry, and/or some other data processing components. The microprocessors comprise Digital Signal Processors (DSP), Central Processing Units (CPU), Graphical Processing Units (GPU), Application-Specific Integrated Circuits (ASIC), and/or some other data processing hardware. The memories comprise Random Access Memory (RAM), flash circuitry, disk drives, and/or some other type of data storage. The memories store software like operating systems, utilities, protocols, applications, and functions. The microprocessors retrieve the software from the memories and execute the software to drive the operation of data communication system 100 as described herein.

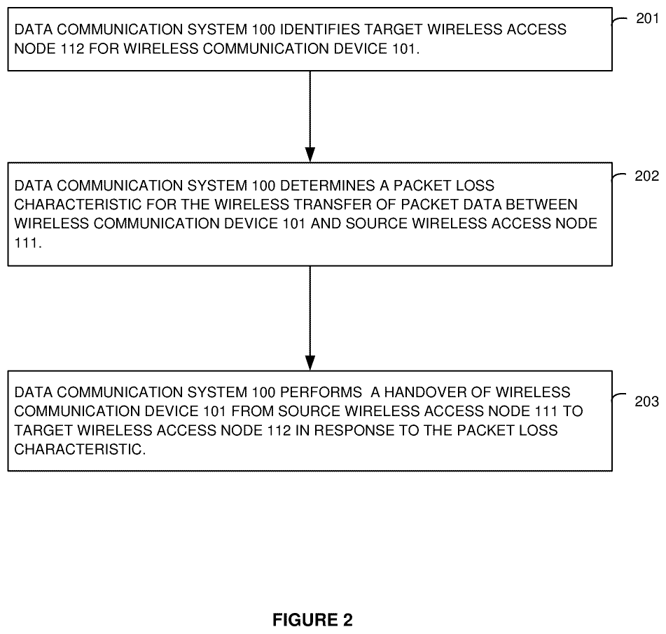

FIG. 2 illustrates an exemplary operation of data communication system 100 to handover wireless communication device 101 based on packet loss. The operation may differ in other examples. Data communication system 100 identifies target wireless access node 112 for wireless communication device 101 (201). Data communication system 100 determines a packet loss characteristic for the wireless transfer of packet data between wireless communication device 101 and source wireless access node 111. (202). Data communication system 100 performs a handover of wireless communication device 101 from source wireless access node 111 to target wireless access node 112 in response to the packet loss characteristic (203).

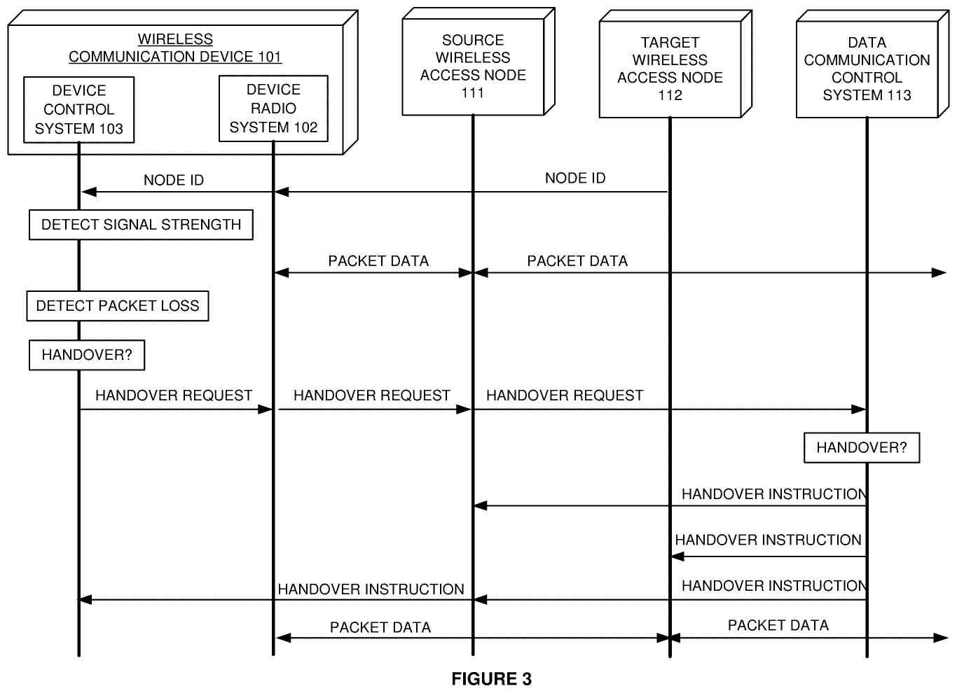

FIG. 3 illustrates an exemplary operation of data communication system 100 to handover wireless communication device 101 based on packet loss. The operation may differ in other examples. Device control system 103 receives a target signal from target wireless access node 112 over device radio system 102. The target signal indicates a node identifier (ID) for target wireless access node 112. Device control system 103 identifies target wireless access node 112 and determines signal strength for the target signal. Device radio system 102 and source wireless access node 111 wirelessly exchange packet data. Device control system 103 determines a packet loss rate (the percentage of lost packets to total packets) for the wireless transfer of the packet data between device radio system 102 and source wireless access node 111. When the packet loss rate exceeds a loss threshold for the type of wireless communication device 101, and the target signal strength is adequate, device control system 103 requests a handover from source wireless access 111 node to target wireless access node 112. The handover request indicates the packet loss rate and the target signal strength. When the packet loss rate exceeds the loss threshold for the device type and the target signal strength is adequate, data communication control system 113 initiates the handover of wireless communication device 101 from source wireless access node 111 to target wireless access node 112. To initiate the handover, data communication control system 113 transfers handover instructions to source wireless access node 111, target wireless access node 112, and device control system 103 (over source wireless access node 111 and device radio system 102). After the handover, device radio system 102 and target wireless access node 112 wirelessly transfer packet data.

Advantageously, data communication system 100 efficiently and effectively hands over wireless communication device based on packet loss. Moreover, data communication system 100 may use a packet loss level that is based on the type of wireless communication device 101 to trigger the handover.

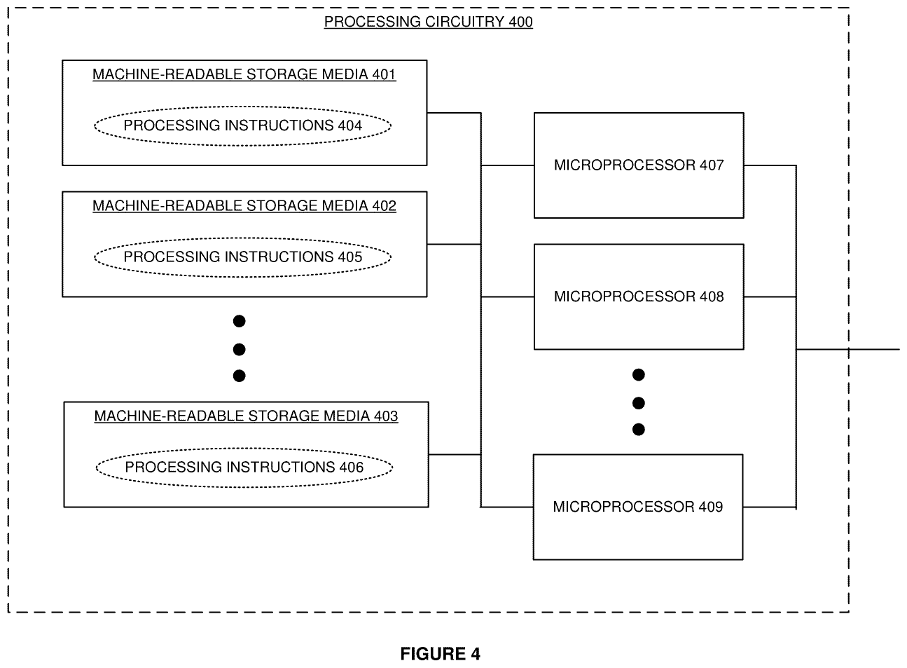

FIG. 4 illustrates exemplary processing circuitry 400 to handover a wireless communication device based on packet loss. Processing circuitry 400 comprises an example of wireless communication device 101, wireless access nodes 111-112, and data communication control system 113, although device 101, nodes 111-112, and/or system 113 may differ. Processing circuitry 400 comprises machine-readable storage media 401-403 and microprocessors 407-409 that are communicatively coupled. Machine-readable storage media 401-403 store processing instructions 404-406 in a non-transitory manner. Microprocessors 407-409 comprise DSPs, CPUs, GPUs, ASICs, and/or some other data processing hardware. Machine-readable storage media 401-403 comprises RAM, flash circuitry, disk drives, and/or some other type of data storage apparatus. Microprocessors 407-409 retrieve processing instructions 404-406 from non-transitory machine-readable storage media 401-403. Microprocessors 407-409 execute processing instructions 404-406 to handover a wireless communication device based on packet loss as described above for data communication system 100 and as described below for wireless communication network 500. The amount of storage media, microprocessors, processing instructions that are shown in FIG. 4 may vary in other examples.

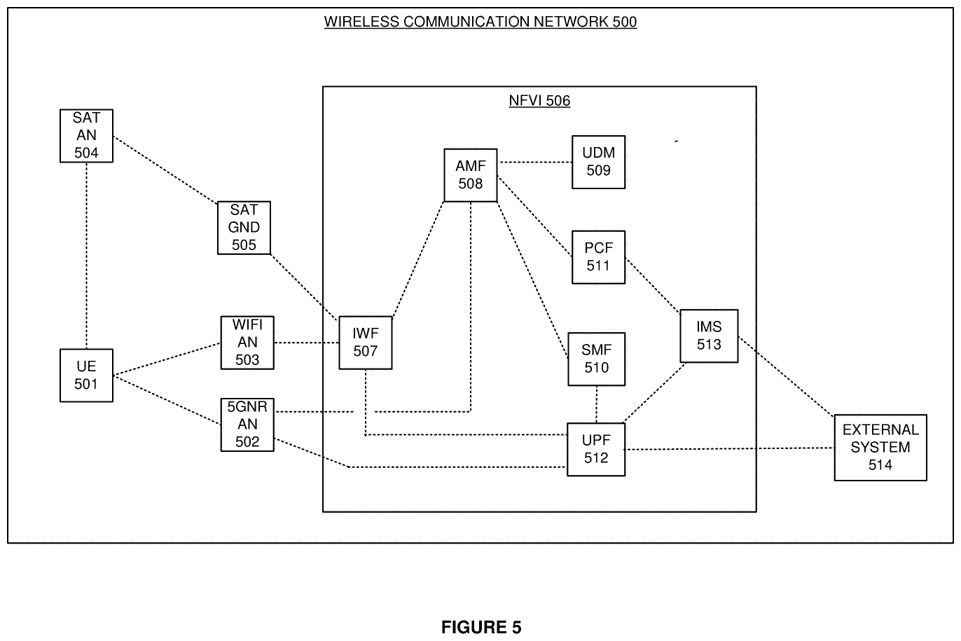

FIG. 5 illustrates exemplary wireless communication network 500 that hands over wireless User Equipment (UE) 501 based on packet loss. Wireless communication network 500 comprises an example of data communication system 100 and processing circuitry 400, although system 100 and circuitry 400 may differ. Wireless communication network 500 comprises User Equipment (UE) 501, Fifth Generation New Radio (5GNR) Access Node (AN) 502, Wireless Fidelity (WIFI) AN 503, earth satellite (SAT) AN 504, satellite ground station (SAT GND) 505, and Network Function Virtualization Infrastructure (NFVI) 506. NFVI 506 comprises Interworking Function (IWF) 507, Access and Mobility Management Function (AMF) 508, Unified Data Management (UDM) 509, Session Management Function (SMF) 510, Policy Control Function (PCF) 511, User Plane Function (UPF) 512, and Internet Protocol Multimedia Subsystem (IMS) 513. For clarity, a single IWF 507 is depicted as serving both WIFI AN 503 and SAT GND 505 but different IWFs could be used-IWF 507 for WIFI AN 503 and another IWF for SAT GND 505. For clarity, a single UPF 513 is depicted as serving both 5GNR AN 502 and IWF 507 but different UPFs could be used-UPF 512 for 5GNR AN 502, another UPF for IWF 507, and another UPF for the IWF that serves SAT GND 505.

In some examples, UE 501 hands over from WIFI AN 503 to 5GNR AN 502. UE 501 receives a pilot signal from 5GNR AN 501, and in response, transfers a service request to AMF 508 over 5GNR AN 502. AMF 508 retrieves subscriber information for UE 501 from UDM 509. AMF 508 and SMF 510 develop UE context like network addressing, default bearers, and quality-of-service. SMF 510 transfers UE context to UPF 512. AMF 508 transfers UE context to 5GNR AN 502 and to UE 501 over 5GNR AN 502. The default bearers include an IMS bearer between UE 501 and IMS 513 over 5GNR AN 502 and UPF 512.

UE 501 registers with WIFI AN 503. UE 501 registers with IWF 507 over WIFI AN 503. UE 501 registers with AMF 508 over WIFI AN 503 and IWF 507. AMF 508 retrieves subscriber information for UE 501 from UDM 509. AMF 508 and SMF 510 develop UE context like network addressing, default bearers, and quality-of-service. The UE context also indicates UE type along with a packet loss level, jitter threshold, time interval, and target signal strength threshold for the UE type. In this example, the UE type for UE 501 comprises an advanced UE with excellent radio and computing components. The packet loss level is 10%. The time interval is two seconds. The jitter threshold is 300 Milliseconds (mS). The target signal strength threshold is −95 decibel-milliwatts (DBm). SMF 510 transfers UE context to UPF 512. AMF 508 transfers UE context to IWF 507 and to UE 501 over IWF 507 and WIFI AN 503. The default bearers may include an IMS bearer between UE 501 and IMS 513 over WIFI AN 503, IWF 507, and UPF 512. In response to the UE context, UE 501 registers with IMS 513 over one of the default bearers. Session Initiation Protocol (SIP) or some other IP control format could be used between UE 501 and IMS 513.

UE 501 places a voice/video call to external system 514 by transferring SIP signaling to IMS 513 over one of the default bearers. IMS 513 exchanges SIP signaling with external system 514 or with another IMS for external system 514. IMS 513 receives a network address for external system 514 in the SIP signaling. IMS 513 forwards the network address for external system 514 to UE 501 in SIP signaling over a default bearer. UE 501 uses its own network address and the network address for external system 514 to exchange voice/video packets with external system 514 over WIFI AN 503, IWF 507, and UPF 512. UE 501 may use Real-time Transfer Protocol (RTP) or some other media-streaming format. UE 501 monitors RTP packet loss and jitter for successive two second time intervals and calculates the average RTP packet loss rate and average jitter delay for each time interval.

When the average packet loss rate exceeds 10%, the average jitter delay exceeds 300 milliseconds, and the average signal strength for 5GNR AN 502 exceeds −95 DBm, UE 501 transfers a handover request to AMF 508 over WIFI AN 503 and IWF 507. The handover request indicates the average packet loss rate, the average jitter delay, and the average 5GNR AN 502 signal strength. When the average packet loss rate exceeds 10%, the average jitter delay exceeds 300 mS, and the average signal strength for 5GNR AN 502 exceeds −95 DBm, AMF 508 initiates the handover by signaling SMF 510, 5GNR AN 502, and UE 501. SMF 510 signals UPF 512. The signaling to UE 501 traverses IWF 507 and WIFI AN 503 or traverses 5GNR AN 503. In response to the signaling, UE 501 uses its own network address and the network address for external system 514 to exchange voice/video packets with external system 514 over 5GNR AN 502 and UPF 512.

In an alternative configuration, UE 501 might be a cost-effective UE type with less-expensive radio and computing components. The packet loss level is 20%. The time interval is five seconds. The jitter threshold is 400 mS. The target signal strength threshold is −90 DBm. In this alternative configuration, UE 501 monitors RTP packet loss and jitter for successive five second time intervals and calculates the average RTP packet loss rate and jitter delay for each time interval. When the average packet loss rate exceeds 20%, the average jitter delay exceeds 400 milliseconds, and the average signal strength for 5GNR AN 502 exceeds −90 DBm, UE 501 transfers the handover request to AMF 508 over WIFI AN 503 and IWF 507. The handover request indicates the packet loss rate, the average jitter delay, and the average 5GNR AN 502 signal strength. When the average packet loss rate exceeds 20%, the average jitter delay exceeds 400 mS, and the average signal strength for 5GNR AN 502 exceeds −90 DBm, AMF 508 initiates the handover by signaling SMF 510, 5GNR AN 502, and UE 501.

In some examples, UE 501 hands over from SAT AN 504 to 5GNR AN 502. wireless communication device 501 receives the pilot signal from 5GNR AN 502 and establishes the default bearer over 5GNR AN 502 as described above. UE 501 registers with SAT AN 504. UE 501 registers with IWF 507 over SAT AN 504 and SAT GND 505. UE 501 registers with AMF 508 over SAT AN 504, SAT GND 505, and IWF 507. AMF 508 retrieves subscriber information for UE 501 from UDM 509. AMF 508 and SMF 510 develop UE context like network addressing, default bearers, and quality-of-service. The UE context also indicates UE type along with a packet loss level, jitter threshold, time interval, and target signal strength threshold for the UE type. SMF 510 transfers UE context to UPF 512. AMF 508 transfers UE context to IWF 507 and to UE 501 over IWF 507, SAT GND 505, and SAT AN 504. The default bearers may include an IMS bearer between UE 501 and IMS 513 over SAT AN 504, SAT GND 505, IWF 507, and UPF 512. In response to the UE context, UE 501 registers with IMS 513 over one of the default bearers.

UE 501 places a voice/video by call transferring SIP signaling to IMS 513 over one of the default bearers. IMS 513 exchanges SIP signaling with external system 514 or another IMS that serves external system 514. IMS 513 forwards the network address for external system 514 to UE 501. UE 501 uses its own network address and the one for external system 514 to exchange voice/video packets with external system 514 over SAT AN 504, SAT GND 505, IWF 507, and UPF 512. UE 501 monitors RTP packet loss and jitter for successive time intervals and calculates the average RTP packet loss rate and jitter delay for each time interval. When the average packet loss rate exceeds 15%, the average jitter delay exceeds 350 milliseconds, and the average signal strength for 5GNR AN 502 exceeds −92 DBm, UE 501 transfers a handover request to AMF 508 over SAT AN 504, SAT GND 505, and IWF 507. The handover request indicates the average packet loss rate, the average jitter delay, and the average 5GNR AN 502 signal strength. When the average packet loss rate exceeds 15%, the average jitter delay exceeds 350 mS, and the average signal strength for 5GNR AN 502 exceeds the −92 DBm, AMF 508 initiates the handover by signaling SMF 510, 5GNR AN 502, IWF 507, SAT AN 504, and UE 501. SMF 510 signals UPF 512. The signaling to UE 501 traverses SAT AN 504, SAT GND 505, and IWF 507 or traverses 5GNR AN 502. In response to the signaling, UE 501 uses its network address and the one for external system 514 to exchange voice/video packets with the external system 514 over 5GNR AN 502 and UPF 512.

In some examples, UE 501 hands over from WIFI AN 503 to SAT AN 503. UE 501 receives a pilot signal from SAT AN 504 and registers with SAT AN 504. UE 501 registers with IWF 507 over SAT AN 504 and SAT GND 505. UE 501 registers with AMF 508 over SAT AN 504, SAT GND 505, and IWF 507. AMF 508 retrieves subscriber information for UE 501 from UDM 509. AMF 508 and SMF 510 develop UE context like network addressing, default bearers, and quality-of-service. SMF 510 transfers UE context to UPF 512. AMF 508 transfers UE context to IWF 507 and SAT AN 504. AMF 508 transfers UE context to UE 501 over IWF 507, SAT GND 505, and SAT AN 504. The default bearers may include an IMS bearer between UE 501 and IMS 513 over SAT AN 504, SAT GND 505, IWF 507, and UPF 512.

UE 501 registers with WIFI AN 503. UE 501 registers with IWF 507 over WIFI AN 503. UE 501 registers with AMF 508 over WIFI AN 504 and IWF 507. AMF 508 retrieves subscriber information for UE 501 from UDM 509. AMF 508 and SMF 510 develop UE context like network addressing, default bearers, and quality-of-service. The UE context also indicates UE type along with a packet loss level, jitter threshold, time interval, and target signal strength threshold for the UE type. SMF 510 transfers UE context to UPF 512. AMF 508 transfers UE context to IWF 507. AMF 508 transfers UE context to UE 501 over IWF 507 and WIFI AN 503. The default bearers may include an IMS bearer between UE 501 and IMS 513 over WIFI AN 503, IWF 507, and UPF 512. In response to the UE context, UE 501 registers with IMS 513 over one of the default bearers.

UE 501 places a voice/video by call transferring SIP signaling to IMS 513 over one of the default bearers. IMS 513 exchanges SIP signaling with external system 514 or another IMS that serves external system 514. IMS 513 forwards the network address for external system 514 to UE 501. UE 501 uses its own network address and the one for external system 514 to exchange voice/video packets with external system 514 over WIFI AN 503, IWF 507, and UPF 512. UE 501 monitors RTP packet loss and jitter for successive time intervals and calculates the average RTP packet loss rate and jitter delay for each time interval. When the average packet loss rate exceeds 15%, the average jitter delay exceeds 350 milliseconds, and the average signal strength for SAT AN 504 exceeds −92 DBm, UE 501 transfers a handover request to AMF 508 over WIFI AN 503 and IWF 507. The handover request indicates the average packet loss rate, the average jitter delay, and the average SAT AN 504 signal strength. When the average packet loss rate exceeds 15%, the average jitter delay exceeds 350 mS, and the average signal strength for SAT AN 504 exceeds the −92 DBm, AMF 508 initiates the handover by signaling SMF 510, IWF 507, SAT AN 504, and UE 501. SMF 510 signals UPF 512. The signaling to UE 501 traverses WIFI AN 503 and IWF 507 or traverses SAT AN 504, SAT GND 505, and IWF 507. In response to the signaling, UE 501 uses its network address and the one for external system 514 to exchange voice/video packets with the external system 514 over SAT AN 504, SAT GND 505, IWF 507, and UPF 512.

Either packet loss or jitter could be used by itself or in combination with other data to trigger the above handovers. Handovers from 5GNR AN 502 to WIFI AN 503, from 5GNR AN 502 to SAT AN 504, or from SAT AN 504 to WIFI AN 503 could be handled in a similar manner.

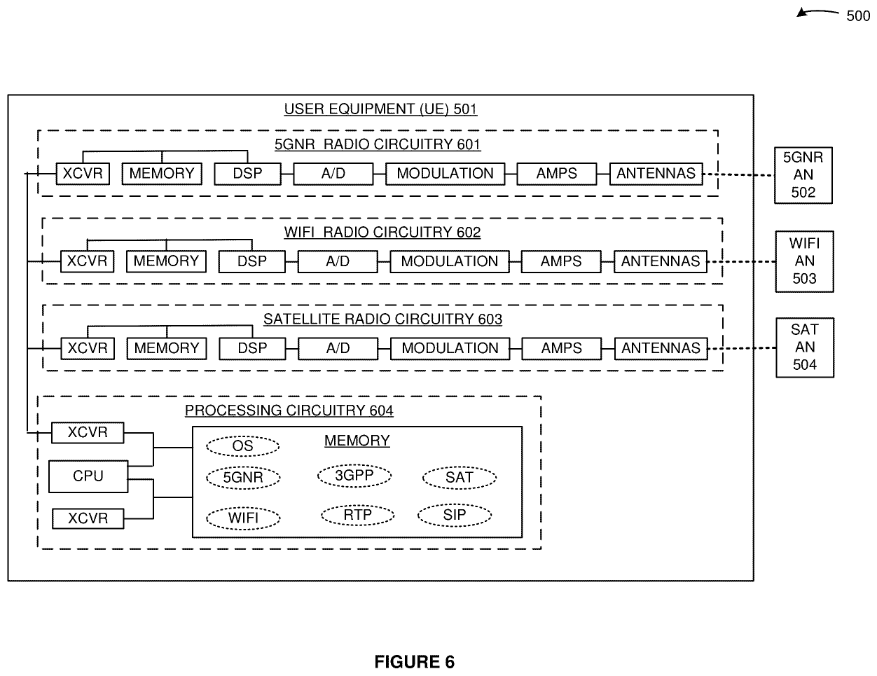

FIG. 6 illustrates exemplary wireless UE 501 in wireless communication network 500 that hands over wireless UE 501 based on packet loss. UE 501 comprises an example of wireless communication device 101 and processing circuitry 400, although device 101 and circuitry 400 may differ. UE 501 comprises Fifth Generation New Radio (5GNR) radio circuitry 601, Wireless Fidelity (WIFI) radio circuitry 602, satellite radio circuitry 603, and processing circuitry 604. Radio circuitry 601-603 comprises antennas, amplifiers, filters, modulation, analog-to-digital interfaces, DSPs, memories, and transceivers (XCVRs) that are coupled over bus circuitry. Processing circuitry 604 comprises one or more CPUs, one or more memories, and one or more transceivers that are coupled over bus circuitry. The one or more memories in processing circuitry 604 store software like an Operating System (OS), 5GNR Application (5GNR), 3GPP Application (3GPP), WIFI Application (WIFI), Satellite Application (SAT), Real Time Protocol application (RTP), and Session Initiation Protocol application (SIP). The antennas in radio circuitry 601-603 exchange wireless signals with ANs 502-505. Transceivers in radio circuitry 601-603 are coupled to transceivers in processing circuitry 604. In processing circuitry 604, the one or more CPUs retrieve the software from the one or more memories and execute the software to direct the operation of UE 501 as described herein.

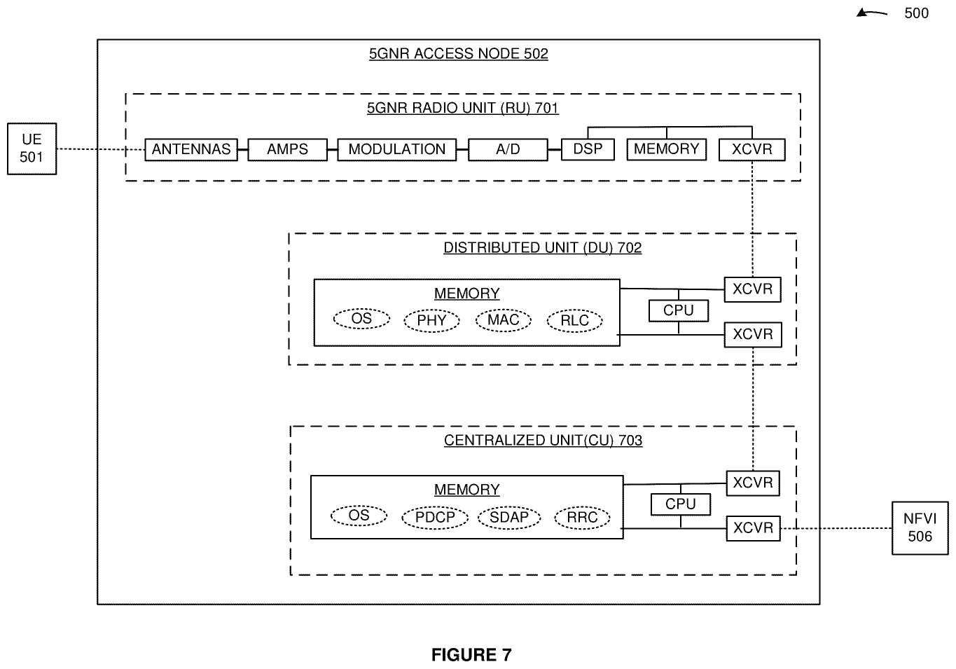

FIG. 7 illustrates an exemplary Fifth Generation New Radio (5GNR) Access Node (AN) 502 in wireless communication network 500 that hands over wireless UE 501 based on packet loss. 5GNR AN 502 comprises an example of wireless access nodes 111-112 and processing circuitry 400, although nodes 111-112 and circuitry 400 may differ. 5GNR AN 502 comprises 5GNR Radio Unit (RU) 701, Distributed Unit (DU) 702, and Centralized Unit (CU) 703. 5GNR RU 701 comprises antennas, amplifiers, filters, modulation, analog-to-digital interfaces, DSP, memory, radio applications, and transceivers that are coupled over bus circuitry. DU 702 comprises memory, CPU, user interfaces and components, and transceivers that are coupled over bus circuitry. The memory in DU 702 stores operating system and 5GNR network applications for Physical Layer (PHY), Media Access Control (MAC), and Radio Link Control (RLC). CU 703 comprises memory, CPU, and transceivers that are coupled over bus circuitry. The memory in CU 703 stores an operating system and 5GNR network applications for Packet Data Convergence Protocol (PDCP), Service Data Adaption Protocol (SDAP), and Radio Resource Control (RRC). The antennas in 5GNR RU 701 are wirelessly coupled to UE 501 over 5GNR links. Transceivers in 5GNR RU 701 are coupled to transceivers in DU 702. Transceivers in DU 702 are coupled to transceivers in CU 703. Transceivers in CU 703 are coupled to transceivers in NFVI 506. The DSP and CPU in RU 701, DU 702, and CU 703 execute the radio applications, operating systems, and network applications to exchange data and signaling between UE 501 and NFVI 506 as described herein.

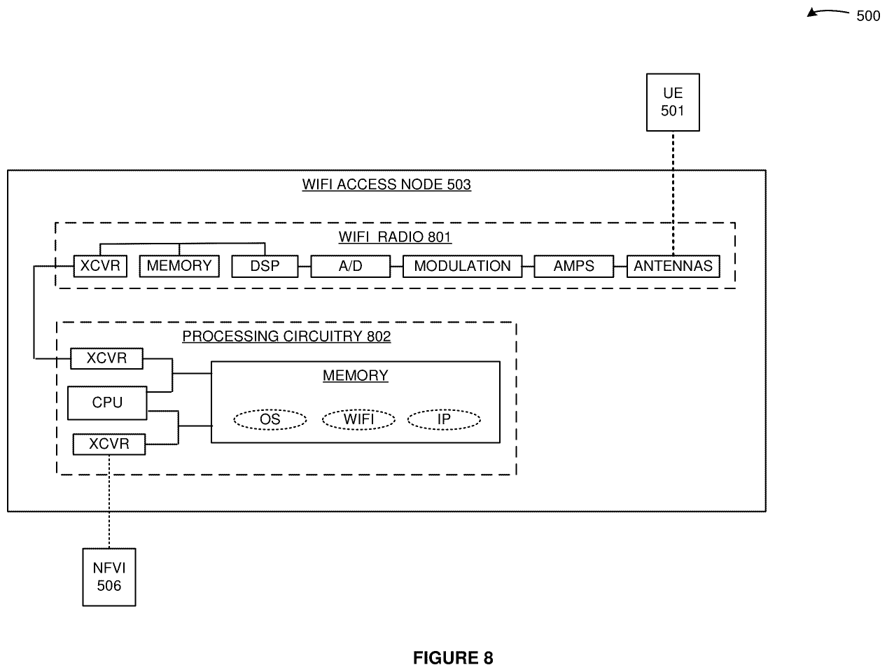

FIG. 8 illustrates exemplary Wireless Fidelity (WIFI) Access Node (AN) 503 in wireless communication network 500 that hands over wireless UE 501 based on packet loss. WIFI AN 503 comprises an example of wireless access nodes 111-112 and processing circuitry 400, although nodes 111-112 and circuitry 400 may differ. WIFI AN 503 comprises WIFI radio 801 and processing circuitry 802. Radio 801 comprises antennas, amplifiers, filters, modulation, analog-to-digital interfaces, DSPs, memories, and transceivers that are coupled over bus circuitry. Processing circuitry 802 comprises one or more CPUs, one or more memories, and one or more transceivers that are coupled over bus circuitry. The one or more memories in processing circuitry 802 store software like an Operating System (OS), WIFI application (WIFI), and IP application (IP). The antennas in WIFI radio 801 exchange WIFI signals with UE 501. Transceivers in radio 801 are coupled to transceivers in processing circuitry 802. Transceivers in processing circuitry 802 are coupled to transceivers in NFVI 506. In processing circuitry 802, the one or more CPUs retrieve the software from the one or more memories and execute the software to exchange data and signaling between UE 501 and NFVI 506 as described herein.

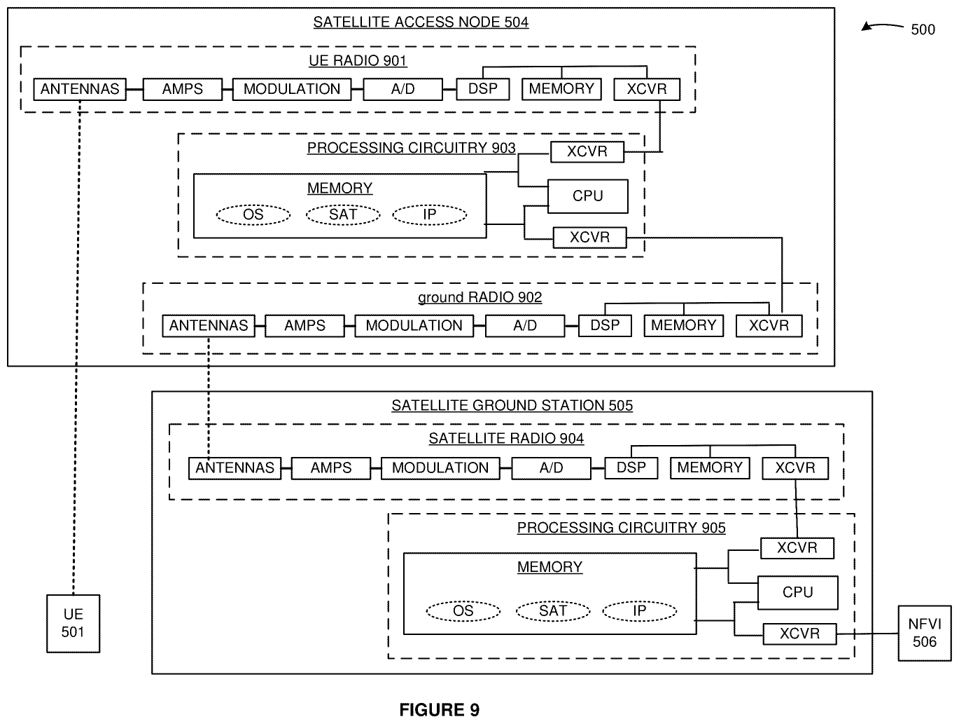

FIG. 9 illustrates exemplary Satellite Access Node (SAT AN) 504 and Satellite Ground Station (SAT GND) 505 in wireless communication network 500 that hands over wireless UE 501 based on packet loss. SAT AN 504 and SAT GND 505 comprise an example of wireless access nodes 111-112, although nodes 111-112 and circuitry 400 may differ. SAT AN 504 comprises UE radio 901, ground radio 902 and processing circuitry 903. SAT GND 505 comprises satellite radio 904 and processing circuitry 905. Radios 901-902 and 904 comprise antennas, amplifiers, filters, modulation, analog-to-digital interfaces, DSPs, memories, and transceivers that are coupled over bus circuitry. Processing circuitry 903 and 905 comprise one or more CPUs, one or more memories, and one or more transceivers that are coupled over bus circuitry. The one or more memories in processing circuitry 903 and 905 store software like an Operating System (OS), Satellite Application (SAT), and IP Application (IP). The antennas in UE radio 901 exchange satellite signals with UE 501. Transceivers in UE radio 901 are coupled to transceivers in processing circuitry 903. Transceivers in processing circuitry 903 are coupled to transceivers in ground radio 902. The antennas in ground radio 902 exchange satellite signals with antennas in satellite radio 904, and the antennas in satellite radio 904 exchange the satellite signals with ground radio 902. Transceivers in satellite radio 904 are coupled to transceivers in processing circuitry 905. Transceivers in processing circuitry 905 are coupled to transceivers in NFVI 506. In processing circuitry 903 and 905, the one or more CPUs retrieve the software from the one or more memories and execute the software to exchange data and signaling between UE 501 and NFVI 506 as described herein.

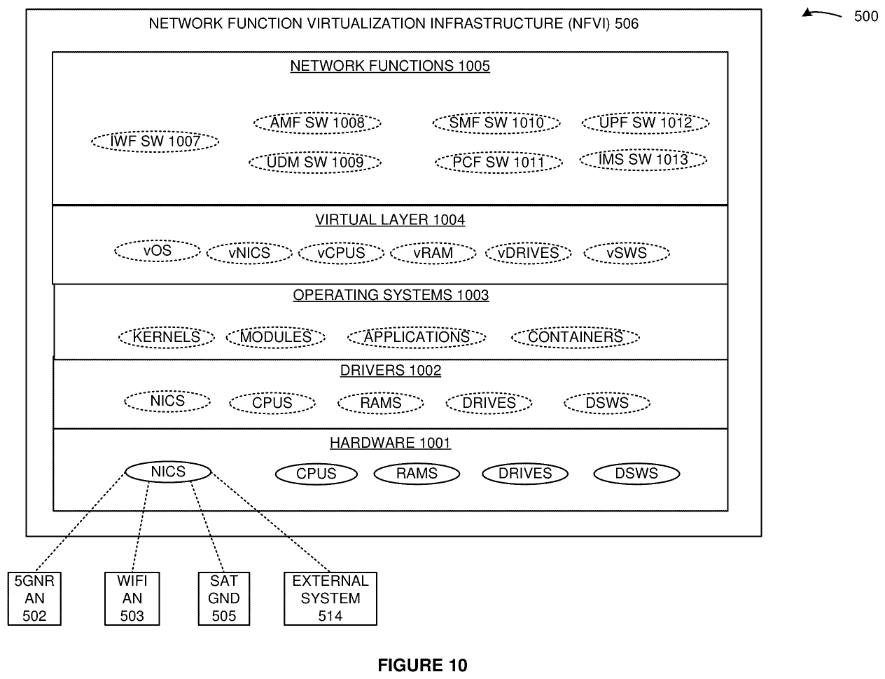

FIG. 10 illustrates exemplary Network Function Virtualization Infrastructure (NFVI) 506 in wireless communication network 500 that hands over wireless UE 501 based on packet loss. NFVI 506 comprises an example of data communication control system 113 and processing circuitry 400, although systems 113 and circuitry 400 may differ. NFVI 506 comprises hardware 1001, hardware drivers 1002, operating systems 1003, virtual layer 1004, and network functions 1005. Hardware 1001 comprises Network Interface Cards (NICS), CPUS, RAM, Flash/Disk Drives (DRIVES), and Data Switches (DSWS). Hardware drivers 1002 comprise software that is resident in the NICS, CPUS, RAM, DRIVES, and DSWS. Operating systems 1003 comprise kernels, modules, applications, and containers. Virtual layer 1004 comprises virtual Operating Systems (vOS), vNICS, vCPUS, vRAM, vDRIVES, and vSWS. Network Functions 1005 comprises IWF SW 1007, AMF SW 1008, UDM SW 1009, SMF SW 1010, PCF SW 1011, UPF SW 1012, and IMS SW 1013. The NICS in hardware 1001 are coupled to ANs 502-503, SAT GND 505, and external system 514. Hardware 1001 executes hardware drivers 1002, operating systems 1003, virtual layer 1004, and network functions 1005 to form and operate IWF 507, AMF 508, UDM 509, SMF 510, PCF 511, UPF 512, and IMS 513 as described herein. NFVI 506 comprises one or more microprocessors and one or more non-transitory machine-readable storage media that store processing instructions that direct NFVI 506 to exchange data and signaling between ANs 502-503, SAT GND 505, and external system 514 as described herein. NFVI 506 may be located at a single site or be distributed across multiple geographic areas.

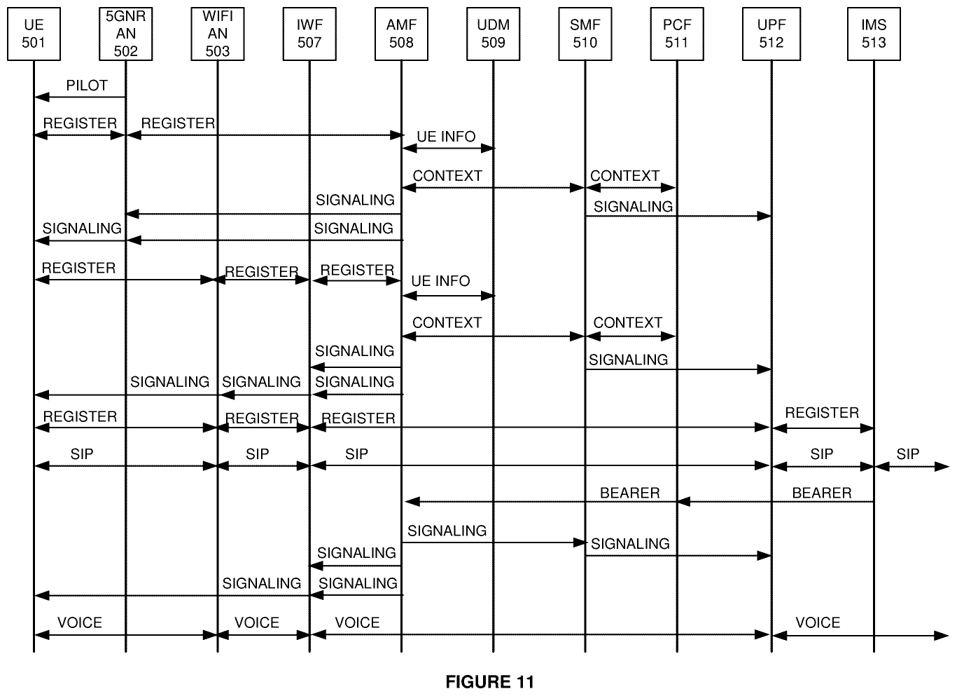

FIG. 11 illustrates an exemplary operation of wireless communication network 500 to handover wireless UE 501 from WIFI AN 503 to 5GNR AN 502 based on packet loss and user application. The operation may differ in other examples. UE 501 receives a pilot signal from 5GNR AN 501, and in response, registers with AMF 508 over 5GNR AN 502. AMF 508 retrieves information for UE 501 from UDM 509. AMF 508, SMF 510, and PCF 511 develop UE context like network addressing, default bearers, and quality-of-service. SMF 510 transfers UE context in signaling to UPF 512. AMF 508 transfers UE context in signaling to 5GNR AN 502. AMF 508 transfers UE context in signaling to UE 501 over 5GNR AN 502. The default bearers include an IMS bearer between UE 501 and IMS 513 over 5GNR AN 502 and UPF 512.

UE 501 registers with AMF 508 over WIFI AN 503 and IWF 507 and indicates a user application. AMF 508 retrieves information for UE 501 from UDM 509. AMF 508, SMF 510, and PCF 511 develop UE context like network addressing, default bearers, and quality-of-service. The UE context also indicates a packet loss level, jitter threshold, time interval, target signal strength threshold for the user application or slice identifier. SMF 510 transfers UE context in signaling to UPF 512. AMF 508 transfers UE context in signaling to IWF 507. AMF 508 transfers UE context in signaling to UE 501 over IWF 507 and WIFI AN 503. The default bearers may include an IMS bearer between UE 501 and IMS 513 over WIFI AN 503, IWF 507, and UPF 512. In response to the UE context, UE 501 registers with IMS 513 over one of the default bearers.

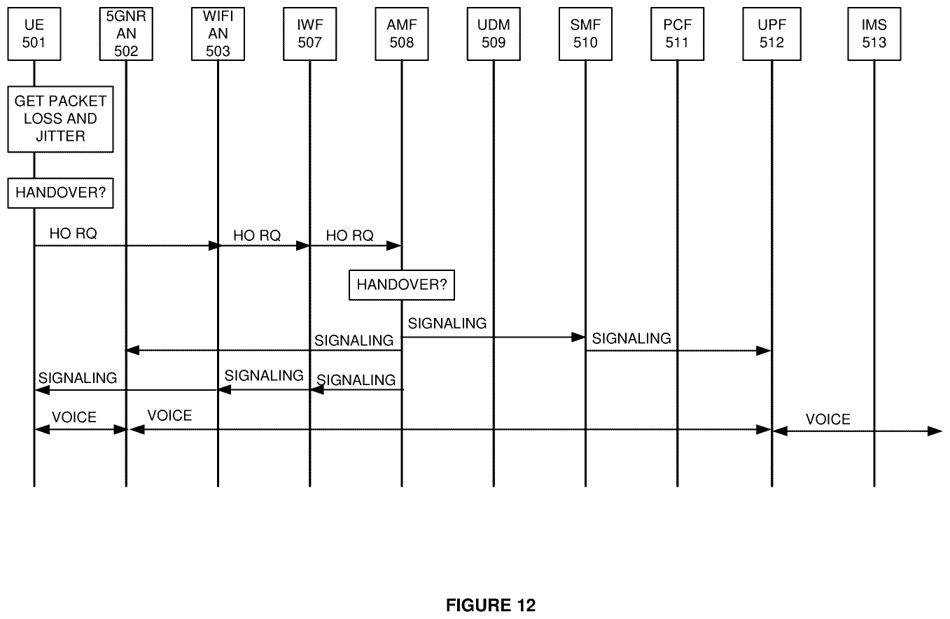

UE 501 places a voice call to external system 514 (not shown) by executing the user application and transferring SIP signaling to IMS 513 over one of the default bearers. IMS 513 exchanges SIP signaling with external system 514 or with another IMS for external system 514. IMS 513 receives a network address for external system 514. IMS 513 forwards the network address for external system 514 to UE 501 in the SIP signaling. IMS 513 orders a bearer for the call from PCF 511. PCF 511 forwards the order to AMF 508. AMF 508 creates the bearer by signaling SMF 510, IWF 507, and UE 501. SMF 510 signals UPF 512. UE 501 uses its own network address and the network address for external system 514 to exchange voice packets with external system 514 over WIFI AN 503, IWF 507, and UPF 512. The operation continues on FIG. 12.

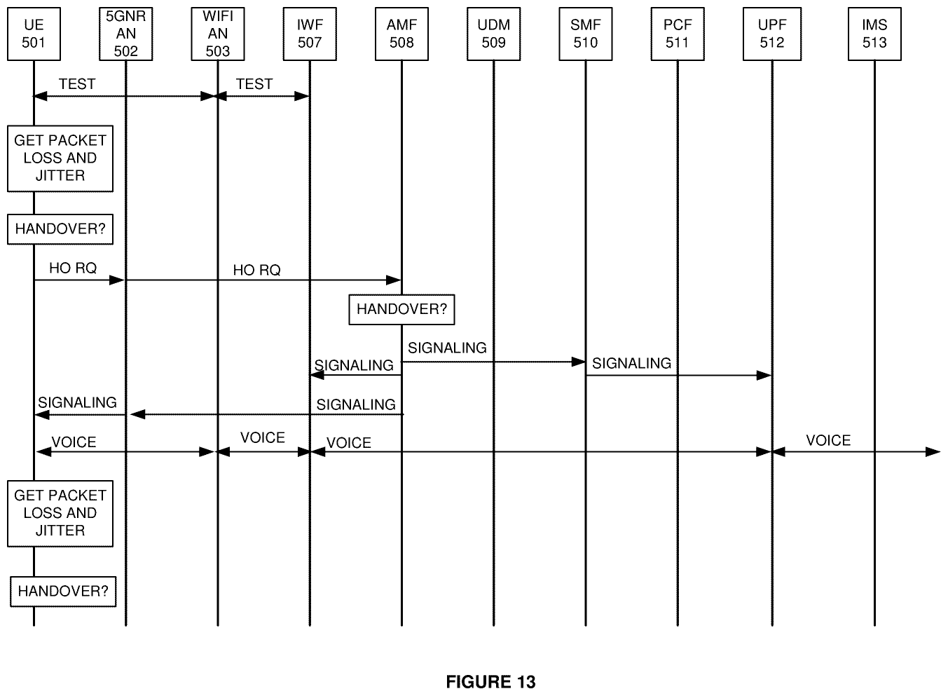

FIG. 12 further illustrates the exemplary operation of wireless communication network 500 to handover wireless UE 501 from WIFI AN 503 to 5GNR AN 502 based on packet loss and user application. The operation continues from FIG. 11 and may differ in other examples. UE 501 monitors packet loss and jitter for successive time intervals per the user application and calculates the packet loss rate and jitter delay for each time interval. When the packet loss rate exceeds the packet loss level for the user application, the jitter delay exceeds the jitter threshold for the user application, and the signal strength for 5GNR AN 502 exceeds the target signal strength level for the user application, UE 501 transfers a handover request to AMF 508 over WIFI AN 503 and IWF 507. A hysteresis time period may be used. The handover request indicates the packet loss rate, the jitter delay, and the 5GNR AN 502 signal strength. When the packet loss rate exceeds the packet loss level for the user application, the jitter delay exceeds the jitter threshold for the user application, and the signal strength for 5GNR AN 502 exceeds the target signal strength threshold for the user application, AMF 508 initiates the handover by signaling SMF 510, 5GNR AN 502, and UE 501. SMF 510 signals UPF 512. In response to the signaling, UE 501 uses its own network address and the network address for external system 514 to exchange voice packets with external system 514 over 5GNR AN 502 and UPF 512. The operation continues on FIG. 13.

FIG. 13 further illustrates the exemplary operation of wireless communication network 500 to handover wireless UE 501 from WIFI AN 503 to 5GNR AN 502 based on packet loss and user application. The operation continues from FIG. 12. UE 501 exchanges test packets with IWF 507 over WIFI AN 503. UE 501 monitors packet loss and calculates the packet loss rate and jitter delay for the test packets. When the packet loss rate falls below the packet loss level for the user application and the jitter delay falls below the jitter threshold for the user application, UE 501 transfers a handover request to AMF 508 over 5GNR AN 502. The handover request indicates the packet loss rate and the jitter delay. When the packet loss rate falls below the packet loss level for the user application and the jitter delay falls below the jitter threshold for the user application, AMF 508 initiates the handover by signaling SMF 510, IWF 507, and UE 501. SMF 510 signals UPF 512. In response to the signaling, UE 501 uses its own network address and the network address for external system 514 to exchange voice packets with external system 514 over WIFI AN 503, IWF 507, and UPF 512. UE 501 monitors packet loss and jitter for successive time intervals per the user application and calculates the packet loss rate and jitter delay for each time interval. If the packet loss rate exceeds the packet loss level for the user application, the jitter delay exceeds the jitter threshold for the user application, and the signal strength for 5GNR AN 502 exceeds the target signal strength level for the user application, UE 501 may request a handover to 5GNR AN 502 as the operation repeats.

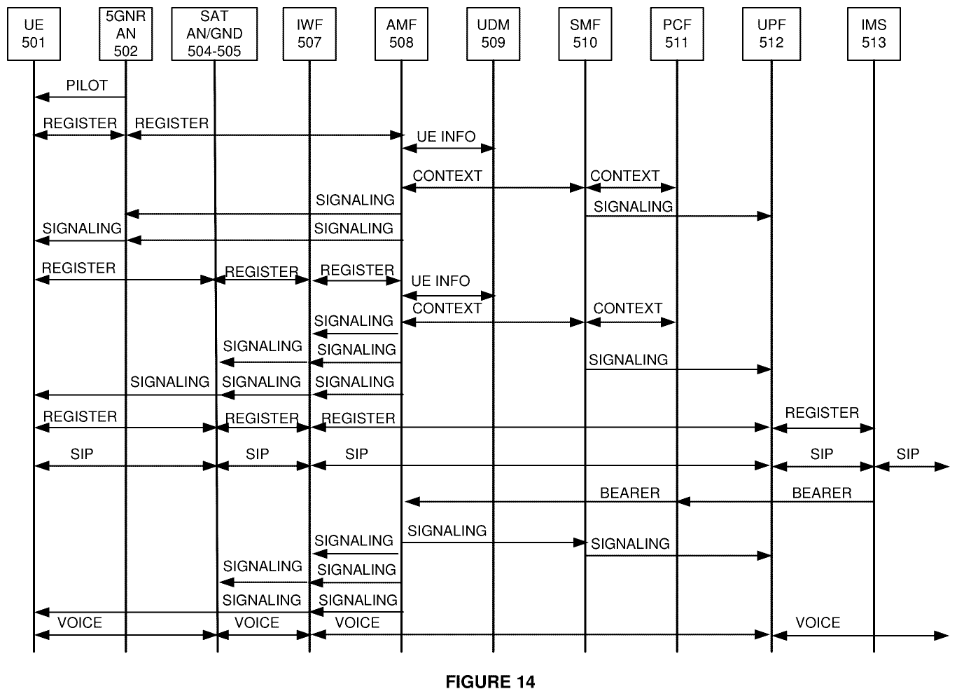

FIG. 14 illustrates an exemplary operation of wireless communication network 500 to handover wireless UE 501 from SAT AN 504 to 5GNR AN 502 based on packet loss and slice identifier. UE 501 receives a pilot signal from 5GNR AN 501, and in response, registers with AMF 508 over 5GNR AN 502. AMF 508 retrieves information for UE 501 from UDM 509. AMF 508, SMF 510, and PCF 511 develop UE context like network addressing, default bearers, and quality-of-service. SMF 510 transfers UE context in signaling to UPF 512. AMF 508 transfers UE context in signaling to 5GNR AN 502. AMF 508 transfers UE context in signaling to UE 501 over 5GNR AN 502. The default bearers include an IMS bearer between UE 501 and IMS 513 over 5GNR AN 502 and UPF 512.

UE 501 registers with AMF 508 over SAT AN/GND 504-505, and IWF 507 and indicates a slice type. AMF 508 retrieves information for UE 501 from UDM 509. AMF 508, SMF 510, and PCF 511 develop UE context like network addressing, default bearers, slice identifier, and quality-of-service. The UE context also indicates a packet loss level for the slice identifier, jitter threshold for the slice identifier, time interval for the slice identifier, and the target signal strength threshold for the slice identifier. SMF 510 transfers UE context in signaling to UPF 512. AMF 508 transfers UE context in signaling to IWF 507. AMF 508 transfers UE context in signaling to SAT AN/GND 504-505. AMF 508 transfers UE context in signaling to UE 501 over IWF 507 and SAT AN/GND 504-505. The default bearers may include an IMS bearer between UE 501 and IMS 513 over SAT AN/GND 504-505, IWF 507, and UPF 512. In response to the UE context, UE 501 registers with IMS 513 over one of the default bearers.

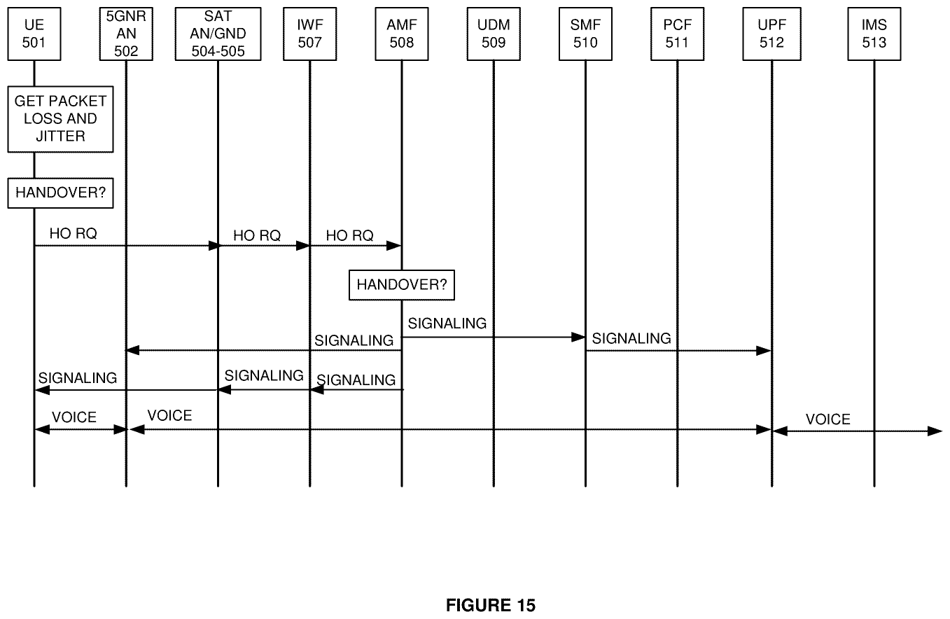

UE 501 places a voice call to external system 514 (not shown) by transferring SIP signaling to IMS 513 over one of the default bearers. IMS 513 exchanges SIP signaling with external system 514 or with another IMS for external system 514. IMS 513 receives a network address for external system 514. IMS 513 forwards the network address for external system 514 to UE 501 in the SIP signaling. IMS 513 orders a bearer for the call from PCF 511. PCF 511 forwards the order to AMF 508. AMF 508 creates the bearer by signaling SMF 510, IWF 507, SAT AN/GND 504-505, and UE 501. SMF 510 signals UPF 512. UE 501 uses its own network address and the network address for external system 514 to exchange voice packets with external system 514 over SAT AN/GND 504-505, IWF 507, and UPF 512. The operation continues on FIG. 15.

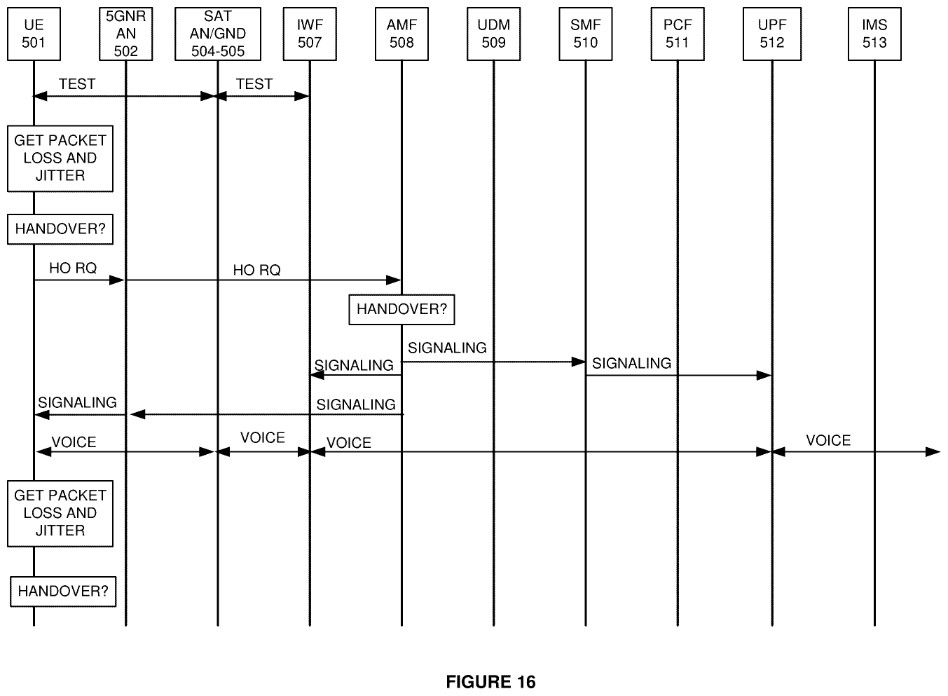

FIG. 15 further illustrates the exemplary operation of wireless communication network 500 to handover wireless UE 501 from SAT AN 504 to 5GNR AN 502 based on packet loss and slice identifier. The operation continues from FIG. 14 and may differ in other examples. UE 501 monitors packet loss and jitter for successive time intervals per the slice identifier and calculates the packet loss rate and jitter delay for each time interval. When the packet loss rate exceeds the packet loss level for the slice identifier, the jitter delay exceeds the jitter threshold for the slice identifier, and the signal strength for 5GNR AN 502 exceeds the target signal strength level for the slice identifier, UE 501 transfers a handover request to AMF 508 over SAT AN/GND 504-505 and IWF 507. The handover request indicates the packet loss rate, the jitter delay, and the 5GNR AN 502 signal strength. When the packet loss rate exceeds the packet loss level for the slice identifier, the jitter delay exceeds the jitter threshold for the slice identifier, and the signal strength for 5GNR AN 502 exceeds the target signal strength threshold for the slice identifier, AMF 508 initiates the handover by signaling SMF 510, SAT AN/GND 504-505, and UE 501. SMF 510 signals UPF 512. In response to the signaling, UE 501 uses its own network address and the network address for external system 514 to exchange voice packets with external system 514 over SAT AN/GND 504-505, IWF 507, and UPF 512. The operation continues on FIG. 16.

FIG. 16 further illustrates the exemplary operation of wireless communication network 500 to handover wireless UE 501 from SAT AN 504 to 5GNR AN 502 based on packet loss and slice identifier. The operation continues from FIG. 15. UE 501 exchanges test packets with IWF 507 over SAT AN/GND 504-505. UE 501 monitors packet loss and calculates the packet loss rate and jitter delay for the test packets. When the packet loss rate falls below the packet loss level and the jitter delay falls below the jitter threshold, UE 501 transfers a handover request to AMF 508 over 5GNR AN 502, and IWF 507. The handover request indicates the packet loss rate and the jitter delay. When the packet loss rate falls below the packet loss level and the jitter delay falls below the jitter threshold, AMF 508 initiates the handover by signaling SMF 510, IWF 507, SAT AN/GND 504-505, and UE 501. SMF 510 signals UPF 512. In response to the signaling, UE 501 uses its own network address and the network address for external system 514 to exchange voice packets with external system 514 over SAT AN/GND 504-505, IWF 507, and UPF 512. UE 501 monitors packet loss and jitter for successive time intervals for the slice identifier and calculates the packet loss rate and jitter delay for each time interval. If the packet loss rate exceeds the packet loss level, the jitter delay exceeds the jitter threshold, and the signal strength for 5GNR AN 502 exceeds the target signal strength level, UE 501 may request a handover to 5GNR AN 502 as the operation repeats.

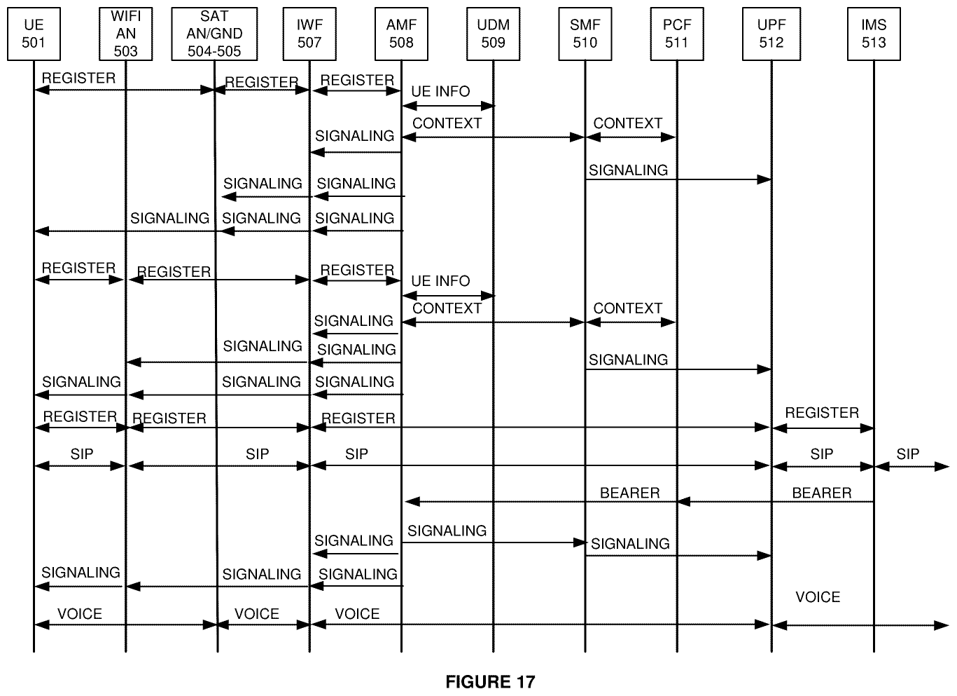

FIG. 17 illustrates an exemplary operation of wireless communication network 500 to handover wireless UE 501 from WIFI AN 503 to SAT AN 504 based on packet loss and UE type. The operation may differ in other examples. UE 501 receives a pilot signal from 5GNR AN 501, and in response, registers with AMF 508 over 5GNR AN 502. AMF 508 retrieves information for UE 501 from UDM 509. AMF 508, SMF 510, and PCF 511 develop UE context like network addressing, default bearers, and quality-of-service. SMF 510 transfers UE context in signaling to UPF 512. AMF 508 transfers UE context in signaling to 5GNR AN 502 and in signaling to UE 501 over 5GNR AN 502. The default bearers include an IMS bearer between UE 501 and IMS 513 over 5GNR AN 502 and UPF 512.

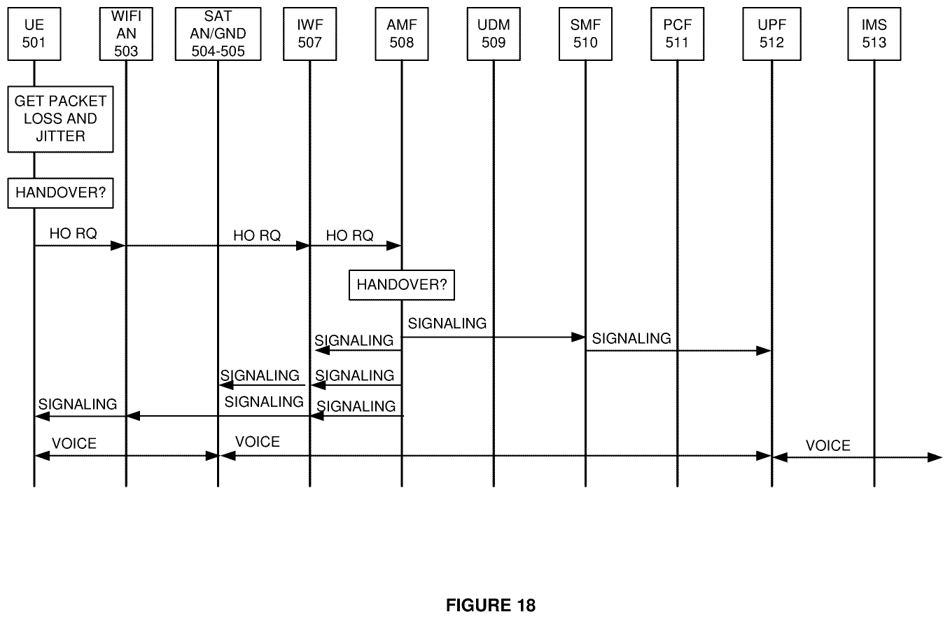

UE 501 registers with AMF 508 over WIFI AN 503 and IWF 507. AMF 508 retrieves information for UE 501 from UDM 509. AMF 508, SMF 510, and PCF 511 develop UE context like network addressing, default bearers, and quality-of-service. The UE context also indicates a packet loss level for the UE type, jitter threshold for the UE type, time interval for the UE type, and target signal strength threshold for the UE type. SMF 510 transfers UE context in signaling to UPF 512. AMF 508 transfers UE context in signaling to IWF 507. AMF 508 transfers UE context in signaling to UE 501 over IWF 507 and WIFI AN 503. The default bearers may include an IMS bearer between UE 501 and IMS 513 over WIFI AN 503, IWF 507, and UPF 512. In response to the UE context, UE 501 registers with IMS 513 over one of the default bearers. UE 501 places a voice call to external system 514 (not shown) by transferring SIP signaling to IMS 513 over one of the default bearers. IMS 513 exchanges SIP signaling with external system 514 or with another IMS for external system 514. IMS 513 receives a network address for external system 514. IMS 513 forwards the network address for external system 514 to UE 501 in the SIP signaling. IMS 513 orders a bearer for the call from PCF 511. PCF 511 forwards the order to AMF 508. AMF 508 creates the bearer by signaling SMF 510, IWF 507, and UE 501. SMF 510 signals UPF 512. UE 501 uses its own network address and the network address for external system 514 to exchange voice packets with external system 514 over WIFI AN 503, IWF 507, and UPF 512. The operation continues on FIG. 18.

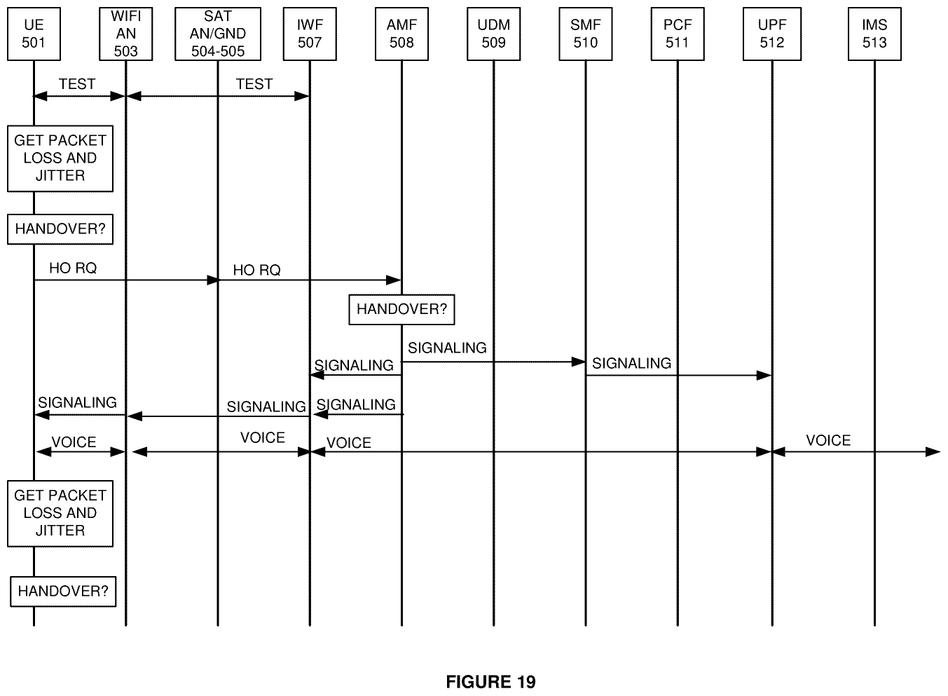

FIG. 18 further illustrates the exemplary operation of the wireless communication network 500 to handover wireless UE 501 from WIFI AN 503 to SAT AN 504 based on packet loss and UE type. The operation continues from FIG. 17 and may differ in other examples. UE 501 monitors packet loss and jitter for successive time intervals and calculates the packet loss rate and jitter delay for each time interval. When the packet loss rate exceeds the packet loss level for the UE type, the jitter delay exceeds the jitter threshold for the UE type, and the signal strength for 5GNR AN 502 exceeds the target signal strength level for the UE type, UE 501 transfers a handover request to AMF 508 over WIFI AN 503 and IWF 507. The handover request indicates the packet loss rate, the jitter delay, and the 5GNR AN 502 signal strength. When the packet loss rate exceeds the packet loss level for the UE type, the jitter delay exceeds the jitter threshold for the UE type, and the signal strength for 5GNR AN 502 exceeds the target signal strength threshold for the UE type, AMF 508 initiates the handover by signaling SMF 510, 5GNR AN 502, and UE 501. SMF 510 signals UPF 512. In response to the signaling, UE 501 uses its own network address and the network address for external system 514 to exchange voice packets with external system 514 over 5GNR AN 502 and UPF 512. The operation continues on FIG. 19.

FIG. 19 further illustrates the exemplary operation of wireless communication network 500 to handover wireless UE 501 from WIFI AN 503 to SAT AN 504 based on packet loss and UE type. The operation continues from FIG. 18 and may differ in other examples. UE 501 exchanges test packets with IWF 507 over WIFI AN 503. UE 501 monitors packet loss and calculates the packet loss rate and jitter delay for the test packets. When the packet loss rate falls below the packet loss level for the UE type and the jitter delay falls below the jitter threshold for the UE type, UE 501 transfers a handover request to AMF 508 over 5GNR AN 502. The handover request indicates the packet loss rate and the jitter delay. When the packet loss rate falls below the packet loss level for the UE type and the jitter delay falls below the jitter threshold for the UE type, AMF 508 initiates the handover by signaling SMF 510, IWF 507, and UE 501. SMF 510 signals UPF 512. In response to the signaling, UE 501 uses its own network address and the network address for external system 514 to exchange voice packets with external system 514 over WIFI AN 503, IWF 507, and UPF 512. UE 501 monitors packet loss and jitter for successive time intervals and calculates the packet loss rate and jitter delay for each time interval. If the packet loss rate exceeds the packet loss level for the UE type, the jitter delay exceeds the jitter threshold for the UE type, and the signal strength for 5GNR AN 502 exceeds the target signal strength level for the UE type, UE 501 may request a handover to 5GNR AN 502 as the operation repeats.

Advantageously, wireless communication network 500 efficiently and effectively hands over wireless UE 501 based on packet loss. Moreover, wireless communication network 500 may use a packet loss level that is based on the type of wireless UE 501 to trigger the handover. The wireless communication system circuitry described above comprises computer hardware and software that form special-purpose data communication circuitry to handover a wireless communication device based on packet loss. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose data communication circuitry system to handover a wireless communication device based on packet loss.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method comprising:
identifying a target wireless access node for a wireless communication device;
determining a packet loss characteristic for a wireless transfer of packet data between the wireless communication device and a source wireless access node; and
requesting a handover of the wireless communication device from the source wireless access node to the target wireless access node in response to the packet loss characteristic.

2. The method of claim 1 further comprising:
identifying a time interval that is based on a type of the wireless communication device; and wherein
determining the packet loss characteristic comprises collecting packet loss information for the time interval during the wireless transfer of the packet data and determining the packet loss characteristic based on the packet loss information.

3. The method of claim 1 further comprising:
identifying a time interval that is based on a type of the wireless communication device; and wherein
requesting the handover in response to the packet loss characteristic comprises requesting the handover in response to the packet loss characteristic and an end of the time interval.

4. The method of claim 1 further comprising:
identifying a packet loss level that is based on a user application in the wireless communication device; and wherein
determining the packet loss characteristic comprises determining a packet loss rate for the wireless transfer of the packet data; and
requesting the handover in response to the packet loss characteristic comprises comparing the packet loss rate for the wireless transfer of the packet data to the packet loss level for the user application in the wireless communication device.

5. The method of claim 1 further comprising:
determining a jitter characteristic for the wireless transfer of the packet data; and wherein requesting the handover in response to the packet loss characteristic comprises requesting the handover in response to the packet loss characteristic and the jitter characteristic.

6. The method of claim 1 wherein:
identifying the target wireless access node for the wireless communication device comprises determining a signal strength characteristic for the target wireless access node; and requesting the handover in response to the packet loss characteristic comprises requesting the handover in response to the packet loss characteristic for the wireless transfer of the packet data and the signal strength characteristic for the target wireless access node.

7. The method of claim 1 wherein:
the source wireless access node comprises a wireless fidelity access node; and the target wireless access node comprises an earth satellite access node.

8. A method comprising:
a source wireless access node wirelessly exchanging packet data with a wireless communication device;
a data communication control system identifying a target wireless access node for the wireless communication device;
the data communication control system identifying a packet loss characteristic for the wireless exchange of the packet data between the source wireless access node and the wireless communication device;
the data communication control system initiating a handover of the wireless communication device from the source wireless access node to the target wireless access node in response to the packet loss characteristic; and
the target wireless access node wirelessly exchanging additional packet data with the wireless communication device.

9. The method of claim 8 wherein:
the wireless communication device identifies a time interval that is based on a type of the wireless communication device;
the wireless communication device collects packet loss information during the time interval for the wireless exchange of the packet data and the packet loss characteristic is determined based on the packet loss information; and
the data communication control system initiating the handover in response to the packet loss characteristic comprises initiating the handover in response to the packet loss characteristic and an end of the time interval.

10. The method of claim 8 further comprising:
the data communication control system selecting a packet loss level that is based on a slice identifier for the wireless communication device; and wherein
the data communication control system determining the packet loss characteristic comprises determining a packet loss rate for the wireless exchange of the packet data; and
the data communication control system initiating the handover in response to the packet loss characteristic comprises comparing the packet loss rate for the wireless exchange of the packet data to the packet loss level for the slice identifier for the wireless communication device.

11. The method of claim 8 further comprising:
the data communication control system determining a jitter characteristic for the wireless exchange of the packet data; and wherein
the data communication control system initiating the handover in response to the packet loss characteristic comprises initiating the handover in response to the packet loss characteristic and the jitter characteristic.

12. The method of claim 8 further comprising:
the data communication control system determining a signal strength characteristic for the target wireless access node; and wherein
the data communication control system initiating the handover in response to the packet loss characteristic comprises initiating the handover in response to the packet loss characteristic for the wireless exchange of the packet data and the signal strength characteristic for the target wireless access node.

13. The method of claim 8 wherein:
the source wireless access node comprises a wireless fidelity access node; and the target wireless access node comprises an earth satellite access node.

14. A wireless communication device comprising:
a device radio system to wirelessly transfer packet data between the wireless communication device and a source wireless access node;
the device radio system to wirelessly receive a target signal from a target wireless access node;
a device control system to identify the target wireless access node based on the target signal;
the device control system to determine a packet loss characteristic for the wireless transfer of the packet data between the wireless communication device and the source wireless access node;
the device control system to request a handover from the source wireless access node to the target wireless access node in response to the packet loss characteristic and the target signal; and
the device radio system to wirelessly transfer additional packet data between the wireless communication device and the target wireless access node.

15. The wireless communication device of claim 14 further comprising:
the device control system to identify a time interval that is based on a type of the wireless communication device; and wherein
the device control system is to collect packet loss information for the time interval during the wireless transfer of the packet data and determine the packet loss characteristic based on the packet loss information.

16. The wireless communication device of claim 14 further comprising:
the device control system to identify a time interval that is based on a type of the wireless communication device; and wherein
the device control system is to request the handover in response to the packet loss characteristic and an end of the time interval.

17. The wireless communication device of claim 14 further comprising:
the device control system to identify a packet loss level that is based on a type of the wireless communication device; and wherein
the device control system is to determine a packet loss rate for the wireless transfer of the packet data; and
the device control system is to compare the packet loss rate for the wireless transfer of the packet data to the packet loss level for the type of the wireless communication device to initiate the handover in response to the packet loss characteristic.

18. The wireless communication device of claim 14 further comprising:
the device control system to determine a jitter characteristic for the wireless transfer of the packet data; and wherein
the device control system to initiate the handover in response to the packet loss characteristic and the jitter characteristic.

19. The wireless communication device of claim 14 wherein:
the device control system is to determine a signal strength characteristic for the target wireless access node based on the target signal to identify the target wireless access node for the wireless communication device; and
the device control system is to initiate the handover in response to the packet loss characteristic for the wireless exchange of the packet data and the signal strength characteristic for the target wireless access node.

20. The wireless communication device of claim 14 wherein:
the source wireless access node comprises a wireless fidelity access node; and
the target wireless access node comprises an earth satellite access node.
